(19) United States
(12) Patent Application Publication
(10) Pub. No.: US 2024/0330782 A1
(43) Pub. Date: Oct. 3, 2024

(54) SYSTEM, APPARATUS AND METHOD FOR CURATING TRAVEL BOOKING SEARCHES AND CONTROLLING A DISPLAY TO GENERATE RESULTS

(71) Applicant: Amadeus S.A.S., Biot (FR)

(72) Inventors: Cecile Jouve, Nice (FR); Celine Graire, Grasse (FR); Jessica Papiot, Antibes (FR); Marine Lasserre, Antibes (FR); Nicolas Hebrant, Miami, FL (US)

(21) Appl. No.: 18/244,130

(22) Filed: Sep. 8, 2023

Related U.S. Application Data
(60) Provisional application No. 63/455,647, filed on Mar. 30, 2023.

(51) Int. Cl. G06Q 10/02; G06Q 30/0283

(52) U.S. Cl. CPC G06Q 10/02; G06Q 30/0283

(57) ABSTRACT

The present specification provides, amongst other things, a novel computing resource booking engine that aggregates data from different airlines or other vendors and groups them according to attributes such as price and duration. A computer display device is controlled to generate a grid that includes the airlines in one axis and the attributes long another axis. A user can select different headings or other portions of the grid to generate an expanded based on metadata in the grid.

### CROSS-REFERENCE TO RELATED APPLICATION(S)

This application claims the benefit of U.S. Provisional Patent Application No. 63/455,647, filed Mar. 30, 2023, entitled “SYSTEM, APPARATUS AND METHOD FOR CURATING TRAVEL BOOKING SEARCHES AND CONTROLLING A DISPLAY TO GENERATE RESULTS”; the entire contents of which is incorporated herein by reference.

### BACKGROUND

Internet searches for flight options often necessitate repeated attempts to find the ideal choice due to several factors. Firstly, the dynamic nature of airfare pricing, which is influenced by ever-changing supply and demand, results in fluctuating prices that make it difficult to pinpoint the best option at any given moment. Additionally, the sheer volume of available airlines, routes, and fare classes can overwhelm users with countless possibilities. Furthermore, the presence of various online travel agencies and meta-search engines that aggregate data from multiple sources can sometimes lead to discrepancies in the information displayed. Lastly, individual preferences, such as layover duration, time of departure, and desired amenities, add another layer of complexity to the search process, requiring users to continually refine and repeat their searches to find the most suitable flight option. The repeated searches waste network resources as well as computing resources on the search devices and the servers receiving the queries.

### SUMMARY

An aspect of the present specification provides a method for controlling a graphical interface of a computing device to generate a plurality of data cohorts representing commercial options comprising: generating, on a display device, a grid; the grid having a first axis including attribute headings; the grid having a second axis including vendor headings; generating cells within the grid; each cell including metadata from datasets matching their respective attribute headings and vendor headings; upon receiving a selection of a vendor heading and an attribute heading, generating on the display device a first heading expansion of the metadata of the cell intersecting the vendor heading and the attribute heading; upon receiving a selection of just a vendor heading, generating on the display device an expansion of the metadata from the datasets corresponding to each cell of the vendor heading; and, upon receiving a selection of just an attribute heading, generating on the display device an expansion of the metadata from the datasets corresponding to each cell of the attribute heading.

Another aspect of the specification provides a travel booking engine including a processor configured to:
receive a data signal representing a proposed travel itinerary including an origin, a destination, and a departure date;
query at least one travel database for datasets representing travel actor options satisfying the travel itinerary;
organize, in memory, said datasets by travel actor, price and duration;
generate, on a display device, a grid; the grid including a first axis comprising a price heading and a duration heading; the grid including a second axis comprising at least two travel actor headings;
generate cells within the grid; each cell including metadata from the datasets matching respective travel actor, price and duration criteria;
upon receiving a selection of just the price heading, generate a list elsewhere on the display device including a data expansion of the metadata from the datasets corresponding to each cell in the price heading;
upon receiving a selection of just the duration heading, generate a list elsewhere on the display device including a data expansion of the metadata from the datasets corresponding to each cell in the duration heading;
upon receiving a selection of the price heading and one of the travel actor headings; generate a data heading expansion of the metadata in the cell intersecting the travel actor heading and price heading; and an additional list of items from the datasets corresponding to the travel actor of the selected one of the travel actor headings; and, upon receiving a selection of the duration heading and one of the travel actor headings, generate a data expansion of the metadata in the cell intersecting the travel actor heading and duration heading; and an additional list of items from the datasets corresponding to the travel actor of the selected one of the travel actor headings.

The price heading can be based on the lowest price.

The duration heading can be based on the shortest duration.

The first axis can define a plurality of rows and the second axis can define a plurality of columns.

The additional list of items can be sorted by price or duration.

The processor can be further configured to: upon receiving a selection of just one of the travel actor headings; generate on the display device including a first heading expansion of the metadata cells in the travel actor headings and an additional list of items from the datasets corresponding to the travel actor of the selected one of the travel actor headings.

The data entry signal can further include a return date.

The data entry signal can further include one or more of a fare class and a range of departure dates and a range of return dates.

The present specification also contemplates methods and computer readable media according to the foregoing.

### BRIEF DESCRIPTION OF THE FIGURES

FIG. 1 is a schematic diagram of a system for curating travel booking searches.

FIG. 2 is a block diagram of example internal components of the booking engine of FIG. 1.

FIG. 3 shows a flowchart depicting a method for curating travel booking searches.

FIG. 4 shows the system of FIG. 1 with certain example performance of various blocks from the method of FIG. 3.

FIG. 5 shows example performance of block 316 in the method of FIG. 3 with minimal reference character labelling.

FIG. 6 shows example of FIG. 6 with full reference character labelling.

FIG. 7 shows a flowchart depicting a method for controlling a display with curated travel booking searches.

FIG. 8 shows example performance of block 408 in the method of FIG. 7 with minimal reference character labelling.

FIG. 9 shows example performance of block 408 in the method of FIG. 7 with minimal reference character labelling.

FIG. 10 shows example performance of block 424 in the method of FIG. 7 with minimal reference character labelling.

FIG. 11 shows another example performance of block 408 in the method of FIG. 7 with minimal reference character labelling.

### DETAILED DESCRIPTION

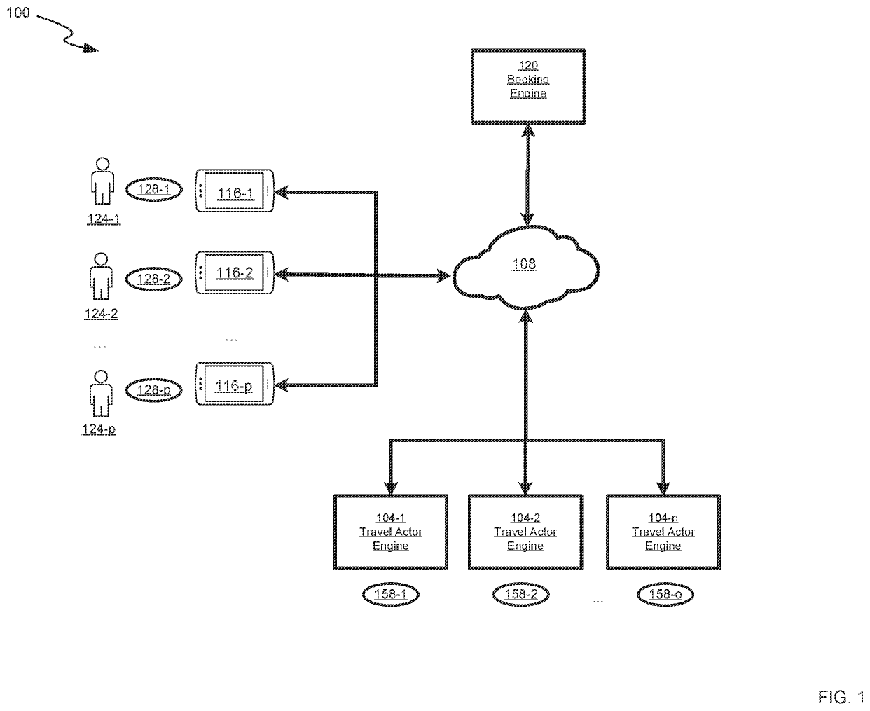

FIG. 1 shows a system for curating travel booking searches indicated generally at 100. System 100 comprises a plurality of travel actor engines 104-1, 104-2 . . . 104-n. (Collectively, engines 104-1, 104-2 . . . 104-n are referred to as engines 104, and generically, as engine 104. This nomenclature is used elsewhere herein.) In system 100, engines 104 connect to a network 108 such as the Internet. Network 108 interconnects travel actor engines 104 with a plurality of client devices 116 and a booking engine 120. As will be discussed further below, booking engine 120 performs a number of processing functions for system 100.

Travel actor engines 104 can be based on any present or future electronic servers or computing architectures that, amongst other things, manage electronic schedules representing on behalf of carriers including their transportation routes, vehicles, fare classes, pricing, seating availability and any other aspects relevant to the operation of a scheduled transportation service available to the public.

Booking engine 120, can be any type of electronic server or computing architecture that facilitates searching and booking interactions between client devices 116 and travel actor engines 104.

Client devices 116 can be any type of human-machine interface for interacting with booking engine 120. For example, client devices 116 can include traditional laptop computers, desktop computers, mobile phones, tablet computers and any other device that can be used to receive and send content that complement the input and output hardware devices associated with a given client device 116. It is contemplated client devices 116 can include virtual or augmented reality gear complementary to virtual reality or augmented reality or “metaverse” environments that can be offered on collaboration engines 104. Client devices 116 can be operated by different users 124 that are associated with a respective identifier object 128 that uniquely identifies a given user 124 accessing a given client device 116 in system 100

The present specification contemplates scenarios where users 124 may travel from certain origins to certain destinations using different modes of travel such as air, rail, bus, ferries, car-pools or the like. Users 124 may thus interact with their devices 116 in order to conduct searches via system 100 to find itineraries offered by different travel actors such as airlines, railway companies, bus companies or other transportation carriers. Users 124 may also ultimately use system 100 to book those itineraries, although presently less-preferred embodiments of this specification also contemplate only a pure searching function.

In a present example embodiment, engines 104 can be based on servers hosted by individual transportation carriers such as airlines, railway companies, bus companies. The individual transportation carrier may rely on the New Distribution Capability (NDC) protocol. Alternatively, or in addition, one or more engines 104 can be based on a Global Distribution System (GDS) such as Amadeus, Sabre, or Travelport, which aggregate data including travel routes and pricing on behalf of individual travel actors. Engines 104 can thus be a combination of servers of individual travel actors using the NDC protocol and GDS aggregators acting on behalf of travel actors.

Accordingly, client devices 116 are based on any suitable client computing platform operated by users 124 that may have an interest in the travel itinerary content being provided by engines 104. Each device 116 and its user 124 is thus typically associated with a user identifier object 128, particularly if any booking functions are to be utilized.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as accounts. The salient point is that they are uniquely identifiable within system 100 in association with what they represent.

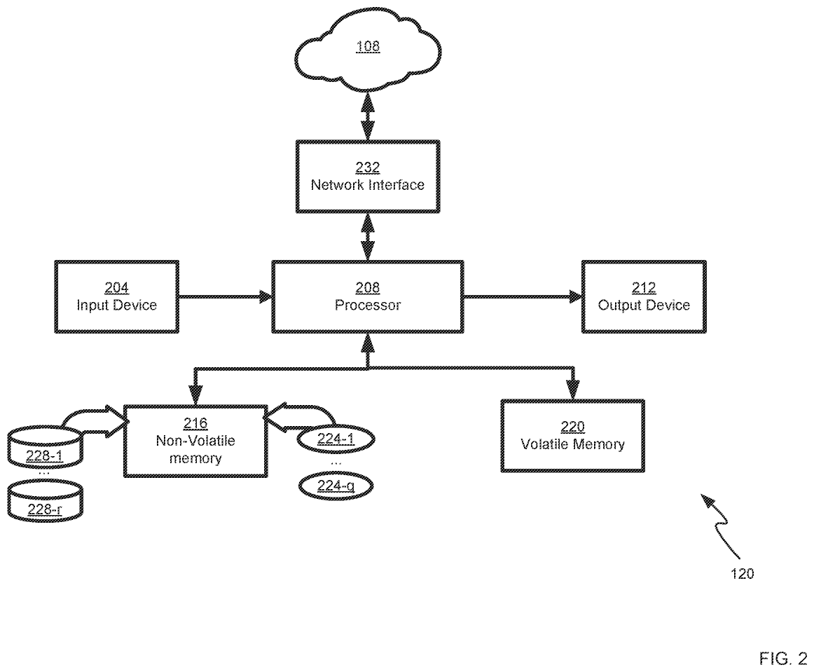

Having described an overview of system 100, it is useful to comment on the hardware infrastructure of system 100. FIG. 2 shows a schematic diagram of a non-limiting example of internal components of booking engine 120.

In this example, booking engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of booking engine 120, or a variant thereon, can be used to implement any of the computing nodes in system 100, including travel actor engines 104. Furthermore, booking engine 120 and travel actor engines 104 may also be implemented as virtual machines and/or with mirror images to provide load balancing. Functions of booking engine 120 may also be distributed amongst different travel actor engines 104 and/or platforms 114, thereby obviating the need for a central booking engine 120. By the same token, a plurality of booking engines 120 may be provided.

Furthermore, a person of skill in the art will recognize that the core elements of processor 208, input device 204, output device 212, non-volatile memory 216, volatile memory 220 and network interface 232, as described in relation to the server environment of booking engine 120, have analogues in the different form factors of client machines such as those that can be used to implement client devices 116. Again, client devices 116 can be based on computer workstations, laptop computers, tablet computers, mobile telephony devices or the like.

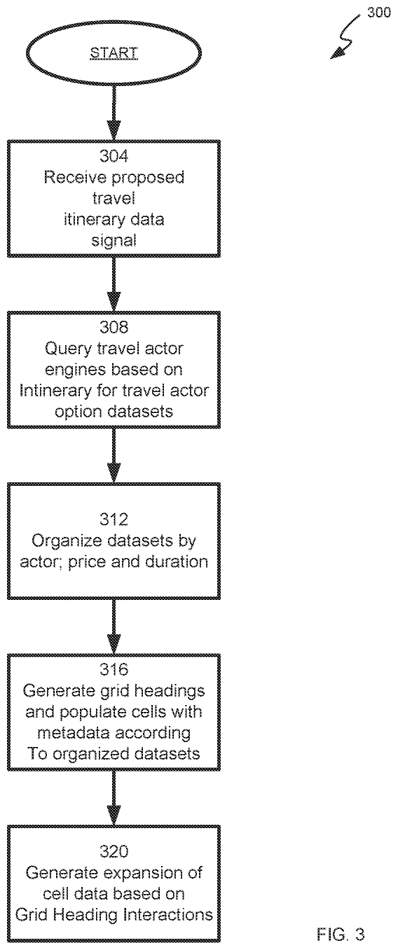

FIG. 3 shows a flowchart depicting a method for curating travel booking searches indicated generally at 300. Method 300 can be implemented on system 100. Persons skilled in the art may choose to implement method 300 on system 100 or variants thereon, or with certain blocks omitted, performed in parallel or in a different order than shown. Method 300 can thus also be varied. However, for purposes of explanation, method 300 will be described in relation to its performance on system 100 with a specific focus on treating method 300 as, for example, application 224-1 maintained within booking engine 120 and its interactions with the other nodes in system 100.

Block 304 comprises receiving a data signal representing a search for a commercial offering such as proposed travel itinerary. In system 100, booking engine 120 receives a request from, for example, device 116-1 for a search for a proposed travel itinerary including an origin, a destination, and a travel departure date. (More complex itinerary searches may also be requested at block 304, and can include other criteria or filters, such as return dates, number of stops, flexible date ranges, preferred fare classes, preferred modes of travel, a selection of a preferred list of carriers, and the like, but for the purposes of this present illustrative example, these other criteria are not discussed explicitly.)

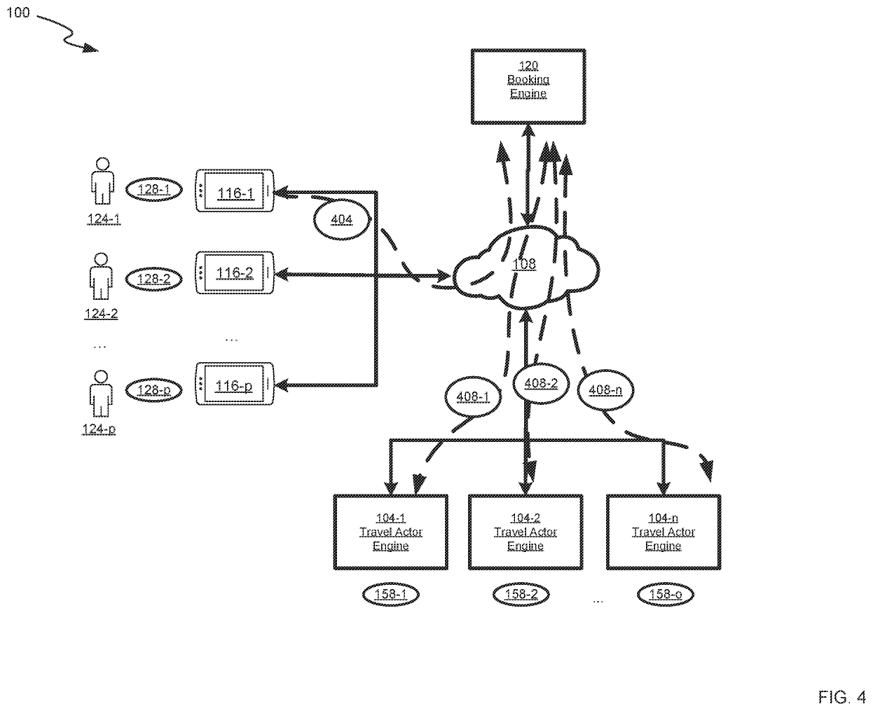

Example performance of block 304 is shown in FIG. 4, where a data signal 404 representing a search for a proposed travel itinerary is sent from device 116-1 to booking engine 120.

Block 308 comprises querying relevant e-commerce vendor platforms based on the data signal received at block 304. In a present example, block 308 comprises querying the travel actor engines 104 (i.e. vendor platforms) that maintain datasets that include travel actor options that are based on the itinerary from block 304. They query can be sent broadly, across a plurality of the travel actor engines 104, and the query response can include a plurality of responses from different travel actors whose data is maintained on those travel actor engines 104. The responses typically each include an identifier of the travel actor, as well as various attributes including the price and duration of the transportation. The price and duration can be considered “metadata”, as the responses will also typically include additional information such as fare restrictions, baggage allowances, aircraft (or other vehicle type), seating options within the fare restrictions, number of stops, layover times, carbon emissions, airport identifiers (or other port identifiers), terminal information, and the like. The type of additional information is not particularly limited, but in general provides greater detail than the metadata.

Example performance of block 308 is also shown in FIG. 4, where query signals 408 is sent to each travel actor engine 104 from booking engine 120 based on the data signal 404. Note that not every travel actor engine 104 need be queried.

Block 312 comprises organizing the datasets from block 308 according to the travel actor (i.e. a specific vendor) and price attributes and duration attributes respective to the proposed travel itinerary. The data received back from engines 104 may be correlated to normalize for different classification approaches used to identify prices, such as seat classes, cancellation options, and the like and classification approaches to identify duration, such as number of stops including stopovers, and the like. In a present example, “Cheapest” and “Fastest” are two classification approaches that are employed.

Block 316 comprises controlling a computer display to generate grid headings and to populate the cells of the grid with selected metadata from the organized datasets of block 312.

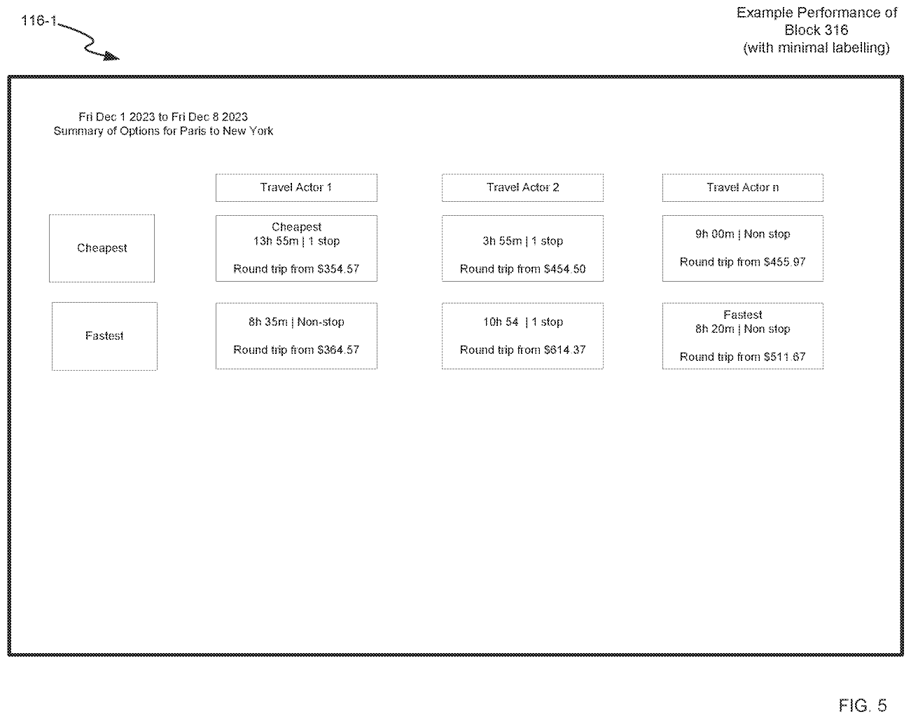

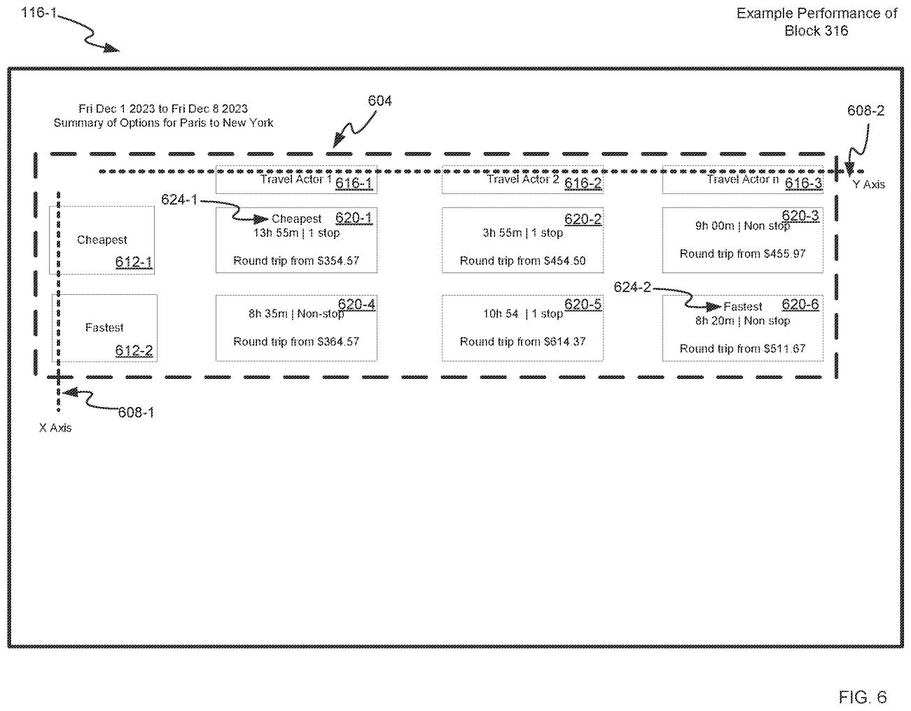

Example performance of Block 316 is shown in FIG. 5 and FIG. 6. FIG. 5 and FIG. 6 are duplicates, except that FIG. 5 is shown without reference characters to represent what is shown on the display of device 116-1, while FIG. 6 includes reference characters to assist in explanation. Further discussion regarding this example performance of block 316 will refer to FIG. 6. In FIG. 6, grid 604 includes a pair of axes 608. In the example of FIG. 6, x-axis 608-1 includes a plurality of attribute headings 612, and y-axis 608-2 includes a plurality of travel actor (i.e. vendor) headings 616.

(As a person skilled in the art continues to read this specification, it will become apparent that the information on each axis could be reversed, in that the attribute headings 612 could be on the y-axis 608-2 and the vendor headings 616 could be on the x-axis 608. Furthermore, other layouts other than grid 604 may be used.)

Grid 604 also includes a plurality of metadata cells 620, which include of a portion of the data retrieved via query signals 408, sorted according to the headings 612 and headings 616.

Notably, the metadata in each cell 620 under the column indicated by heading 616-1 is respective to the data retrieved from engine 104-1; metadata in each cell 620 under the column indicated heading 616-2 is respective to the data retrieved from engine 104-2; and metadata in each cell under the column indicated by heading 616-n is respective to the data retrieved from engine 104-n.

Also notably, the metadata in cells 620 along the row indicated by heading 612-1 is respective to the attribute corresponding to the least expensive or “Cheapest” travel options corresponding to the travel actor engine 104 of the respective heading 616. Furthermore, the metadata in cells 620 along the row indicated by heading 612-2 is respective to the attribute corresponding to the shortest duration or “Fastest” travel options corresponding to the travel actor engine 104 of the respective heading 616.

Furthermore, cell 620-1 also includes an additional label 624-1 indicating “Cheapest”, which represents the fact that the metadata in cell 620-1 represents the overall least expensive travel option. Cell 620-7 also includes an additional label 624-1 indicating “Fastest”, which represents the fact that the metadata in cell 620-1 represents the travel option with the shortest duration. (Note that if two or more options are the same price and are also “Cheapest” then two labels 624-1 may be applied along that row; and likewise if two or more options have the same duration and are also “Fastest” then two labels 624-2 may be applied along that row.)

A person of skill in the art should now understand that, in variants, additional travel actors can be included and that additional and/or different attributes can be included in grid 604. (Additional travel actors can include, by way of non-limiting example, rail, bus or other transportation modes. At least one preferred airline or other travel actor can be specified for inclusion. The additional and/or different attributes can include, by way of non-limiting example, earliest departure; latest departure; earliest arrival; latest arrival; shortest travel time; fewest stops; lowest fare; lowest CO2 emissions; and mode of transportation. A grid can include various combinations of these as desired. The retrieved data can be sorted in ascending or descending according as desired.)

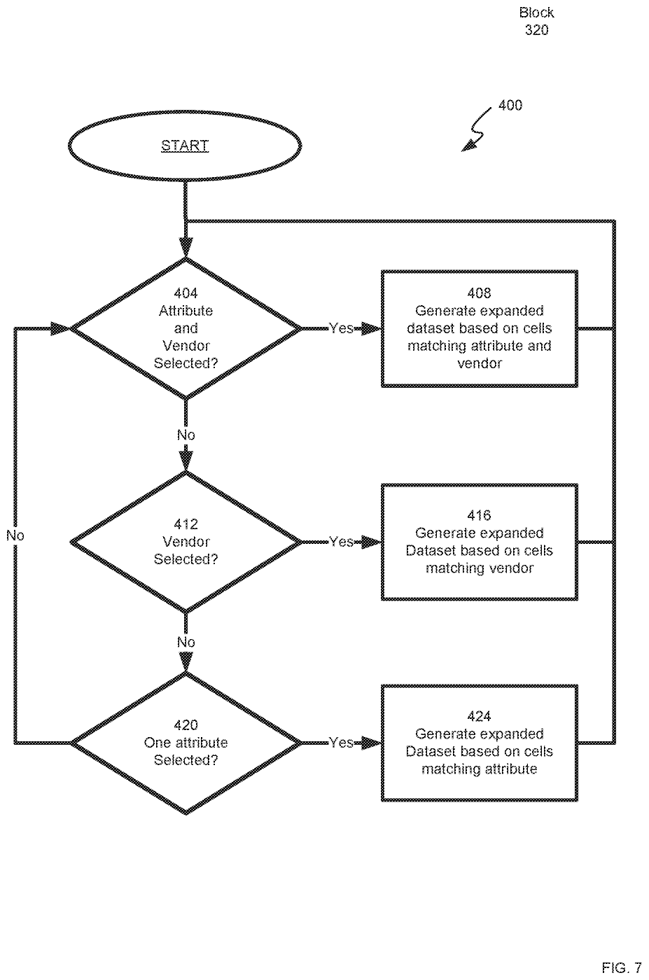

Block 320 comprises generating an expansion of the cell data on the computer display based on interactions with the headings from block 316. In general terms, block 320 contemplates the selection of one or more cells 620 and/or headings 616 which generates additional data on the display of computing device 116. The types of interactions and expansions of data are not particularly limited and can include generation of additional data in the same screen, generation of data on an additional screen, pop-ups or the like. However, FIG. 7 shows a flowchart depicting a method 400 that represents one way that block 320 can be implemented.

Block 404 comprises determining if an attribute and a vendor have been selected. A “yes” determination leads to block 408 which comprises generating an expanded dataset based on cells matching the attribute and the vendor.

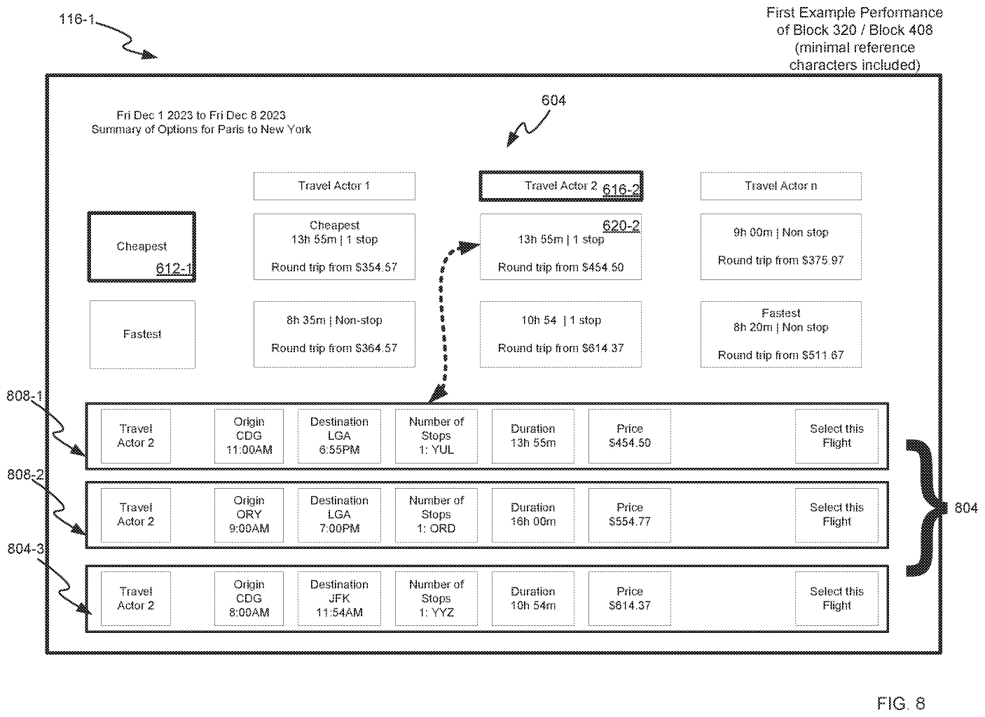

Example performance of block 408 is shown in FIG. 8, where the “Cheapest” heading 612-1 is selected and the “Travel Actor 2” vendor heading 616-2 is selected. The result in FIG. 8 is the generation of a data expansion 804 on the beneath grid 604, which in the present non-limiting examples includes plurality of data rows, referred to herein as fare cards 808. Fare card 808-1 provides further information beyond the metadata in cell 620-2, being the “Cheapest” fare being offered on travel actor engine 104-2. Fare card 808-2 include additional fare options available on travel actor engine 104-2, but not shown in grid 604. In this manner, user 124-1 can quickly access and view the fare options available on travel actor engine 104-2.

(It is to be understood that additional fare cards 808 can be shown and/or made available through scrolling or other means, depending on the available screen size of the display of device 116-1 and the number of available fare cards 808.)

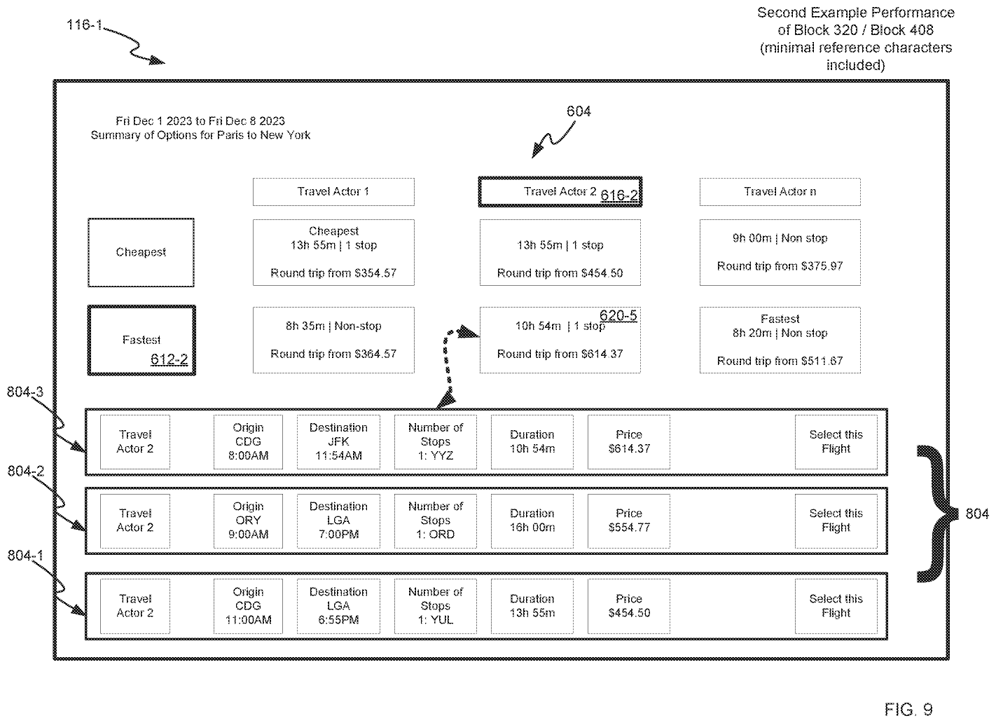

Further example performance of block 408 is shown in FIG. 9, where the “Fastest” heading 612-2 is selected and the “Travel Actor 2” vendor heading 616-2 is selected. Like FIG. 8, the result in FIG. 9 is the generation fare cards 808. However, in FIG. 9, fare cards 808 are prioritized by shortest duration, and thus fare card 804-3 is expanded and shown first providing further information beyond the metadata in cell 620-5, the “Fastest” fare option being offered on travel actor engine 104-2.

Referring again to FIG. 7, a “no” determination at block 404 leads to block 412, and a determination is made as to whether a vendor has been selected. A “yes” determination leads to block 416 which results in generation of an expanded dataset based on the vendor. Note that block 416 is a variant on block 408, except that neither attribute headings 612 has been selected. Thus, the sorting according to heading 612 is not identified in which case, according to our example, the fare cards 808 in either FIG. 7 or FIG. 8 can be generated at block 416. It will be substantially the same except that headings 612 are not shown as highlighted as having been selected.

A “no” determination at block 412 leads to block 420, where a determination is made as to whether an attribute has been selected. A “no” determination at block 420 leads to back to block 404.

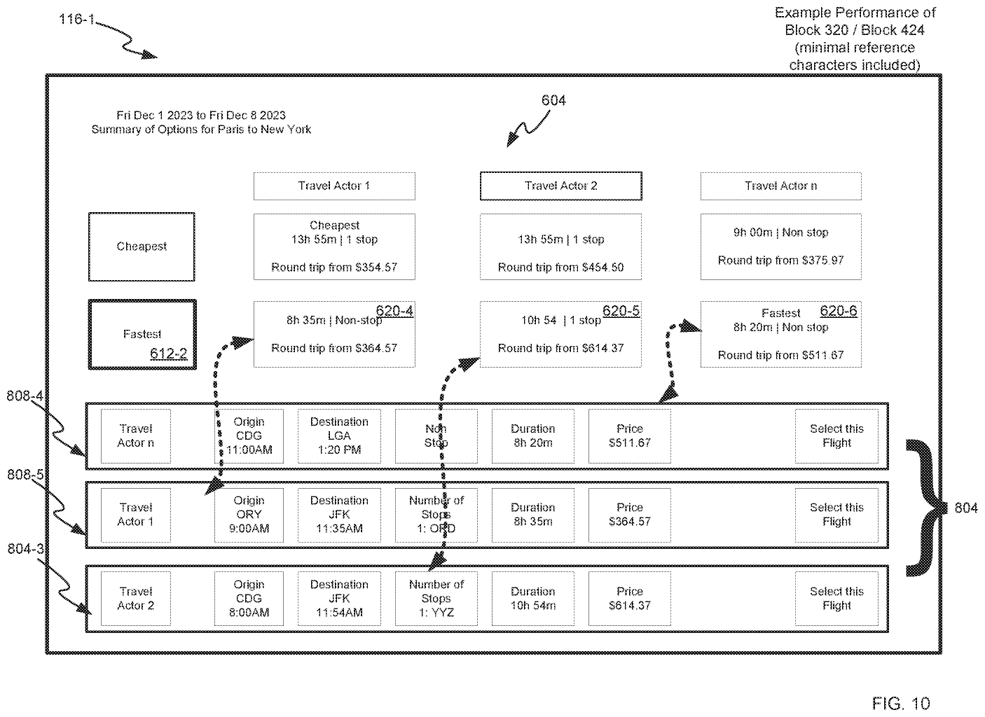

However, a “yes” determination at block 420 leads to block 424, in which case an expanded dataset is shown based on just on the cells matching the selected attribute. Example performance of block 424 is shown in FIG. 10, where the “Fastest” attribute heading 612-2 is selected and the data expansion 804 includes, in order, fare card 808-4, fare card 808-5 and fare card 804-3. Fare card 804-3 is already discussed from previous FIG. 8 and previous FIG. 9 as corresponding to cell 620-5. Fare card 808-4 corresponds to the “Fastest” routing from cell 620-6 and is therefore listed first within data expansion 804. Fare card 808-5 corresponds to the metadata from cell 620-4 and is therefore listed second within data expansion 804 because it has a faster duration that fare card 804-3 but a slower duration than fare card 808-4.

A person of skill in the art will now readily appreciate that the example in FIG. 10 can be repeated for the selection of the “Cheapest” attribute heading 612-1, even though an example of such a scenario is not shown in the Figures.

It is to be reiterated that FIG. 7 is one example of how block 320 can be implemented. As another example, it is contemplated that more than one attribute heading 612 can, in variations, both be selected, while no vendor heading 616 is selected. In this example, fare cards would be sorted based on selection from one of the vendors that is, on average, the “Cheapest” and the “Fastest”, with either attribute being weighted in relation to the other as desired. For example, if two flights are the “Cheapest”, the one with that this the “Fastest” may be displayed first as data expansion 804.

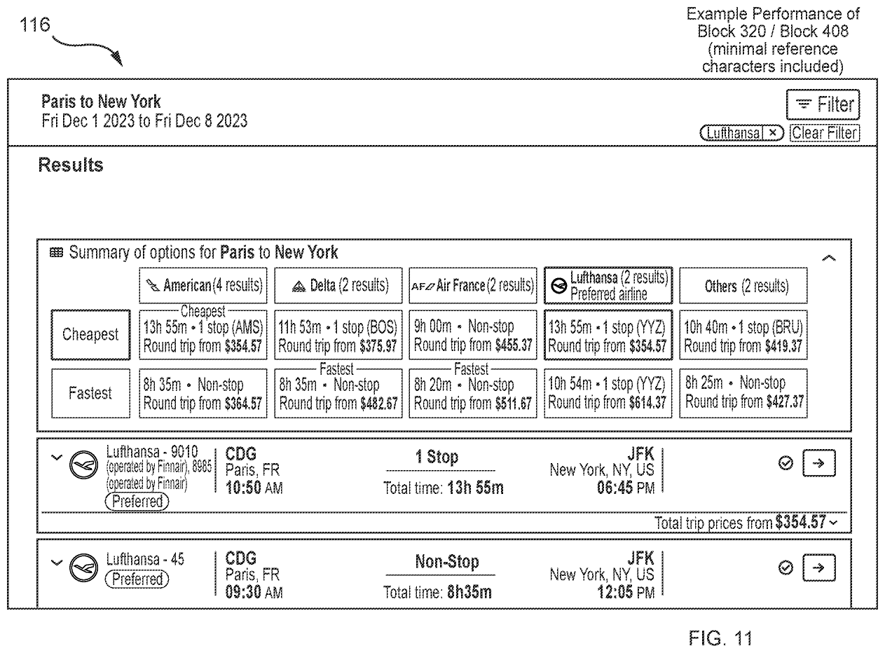

FIG. 11 shows another example of a screen that can be generated on the display of a device 116, only this time specific airlines are shown. (All trademarks belong to their respective owners). In the example of FIG. 11, the travel options for the travel actor “Lufthansa” are shown with the “Cheapest” options listed first.

In view of the above it will now be apparent that variants, combinations, and subsets of the foregoing embodiments are contemplated. For example, while the foregoing discusses travel actors that are involved in transportation services, other types of actors are contemplated. For example the teachings herein can be modified for accommodation, wherein the grid offering includes “Cheapest” and “Most Luxurious”, along with accommodation providers such as hotels, vacation rentals, resorts and B&Bs (“Bed and Breakfasts”). The teachings herein can be expanded to other types of travel actors such as restaurants, spas, concert venues, exhibition centers, summits, sporting event venues, fairs, conference venues, sporting arenas, museums, art galleries, tours and resort activity centers and the like. The teachings herein may be expanded to cover vacation packages that include combinations of transportation, accommodation, meals and/or destination activities.

As another, more generalized example, the concepts of price and/or duration can be abstracted to any two or more variables that can be organized into comparative common metadata across different travel actors. To elaborate, the concept of “duration” can be abstracted out to “quality” or “service level”. In this way, the user 124 can filter for offerings by different travel actors by the cheapest price, or the user 124 can quickly filter for the offerings by different travel actors by the highest service level. In other words, the grid allows user 124 to quickly filter between offerings where the quality of the travel offering is commensurate with its price; and thus the headings of the grid can be expressed accordingly.

Furthermore, the teachings herein can be applied more broadly to any type of commercial offering made over a e-commerce system like system 100, and need not be limited to travel options, in which case booking engine 120 can be substituted for any suitable e-commerce platform. For example, an ecommerce site such as Amazon may have different shipping speeds and associated pricing, and accordingly a user can select a vendor for a given product without having to conduct multiple searches or “add to cart” functions to in order to compare pricing options and shipping speed options.

Furthermore, other graphical representations other than a grid may be employed, although presently less preferred, such as a chord diagram or a radial tree or a nested list or an adjacency list.

A person skilled in the art will now appreciate that the teachings herein can improve the technological efficiency and computational and communication resource utilization across system 100 by curating data and controlling a display device in an fashion that mitigates the need to run multiple searches, thereby reducing the overall burden on traffic resources of network 308 and computational resources on devices 116 and engines 104.

It should be recognized that features and aspects of the various examples provided above can be combined into further examples that also fall within the scope of the present disclosure. In addition, the figures are not to scale and may have size and shape exaggerated for illustrative purposes.

1. A travel booking engine including a processor configured to:
receive a data signal representing a proposed travel itinerary including an origin, a destination, and a departure date;
query at least one travel database for datasets representing travel actor options satisfying the travel itinerary;
organize, in memory, said datasets by travel actor, price and duration;
generate, on a display device, a grid; the grid including a first axis comprising a price heading and a duration heading; the grid including a second axis comprising at least two travel actor headings;
generate cells within the grid; each cell including metadata from the datasets matching respective travel actor, price and duration criteria;
upon receiving a selection of just the price heading, generate a list elsewhere on the display device including a data expansion of the metadata from the datasets corresponding to each cell in the price heading;
upon receiving a selection of just the duration heading, generate a list elsewhere on the display device including a data expansion of the metadata from the datasets corresponding to each cell in the duration heading;
upon receiving a selection of the price heading and one of the travel actor headings; generate a data heading expansion of the metadata in the cell intersecting the travel actor heading and price heading; and an additional list of items from the datasets corresponding to the travel actor of the selected one of the travel actor headings; and,
upon receiving a selection of the duration heading and one of the travel actor headings, generate a data expansion of the metadata in the cell intersecting the travel actor heading and duration heading; and an additional list of items from the datasets corresponding to the travel actor of the selected one of the travel actor headings.

2. The travel booking engine of claim 1 wherein the price heading is based on the lowest price.

3. The travel booking engine of claim 1 wherein the duration heading based on the shortest duration.

4. The travel booking engine of claim 1 wherein the first axis defines a plurality of rows and the second axis defines a plurality of columns.

5. The travel booking engine of claim 1 wherein the additional list of items are sorted by price.

6. The travel booking engine of claim 1 wherein the additional list of items are sorted by duration.

7. The travel booking engine of claim 1 wherein the processor is further configured to: upon receiving a selection of just one of the travel actor headings; generate on the display device including a first heading expansion of the metadata cells in the travel actor headings and an additional list of items from the datasets corresponding to the travel actor of the selected one of the travel actor headings.

8. The travel booking engine of claim 1 wherein the data entry signal further includes a return date.

9. The travel booking engine of claim 1 wherein the data entry signal further includes one or more of a fare class and a range of departure dates and a range of return dates.

10. A method for controlling a graphical interface of a computing device to generate a plurality of data cohorts representing travel options comprising:
receiving a data signal representing a proposed travel itinerary including an origin, a destination, and a departure date;
querying at least one travel database for datasets representing travel actor options satisfying the travel itinerary;
organizing, in memory, said datasets by travel actor, price and duration;
generating, on a display device, a grid; the grid including a first axis comprising a price heading and a duration heading; the grid including a second axis comprising at least two travel actor headings;
generating cells within the grid; each cell including metadata from the datasets matching respective travel actor, price and duration criteria;
upon receiving a selection of just the price heading, generating a list elsewhere on the display device including a data expansion of the metadata from the datasets corresponding to each cell in the price heading;
upon receiving a selection of just the duration heading, generating a list elsewhere on the display device including a data expansion of the metadata from the datasets corresponding to each cell in the duration heading;
upon receiving a selection of the price heading and one of the travel actor headings; generating a data heading expansion of the metadata in the cell intersecting the travel actor heading and price heading; and an additional list of items from the datasets corresponding to the travel actor of the selected one of the travel actor headings; and,
upon receiving a selection of the duration heading and one of the travel actor headings, generating a data expansion of the metadata in the cell intersecting the travel actor heading and duration heading; and an additional list of items from the datasets corresponding to the travel actor of the selected one of the travel actor headings.

11. The method of claim 10 wherein the price heading is based on the lowest price.

12. The method of claim 10 wherein the duration heading based on the shortest duration.

13. The method of claim 10 wherein the first axis defines a plurality of rows and the second axis defines a plurality of columns.

14. The method of claim 10 wherein the additional list of items are sorted by price.

15. The method of claim 10 wherein the additional list of items are sorted by duration.

16. The method of claim 10 further comprising upon receiving a selection of just one of the travel actor headings; generating a list on the display device including a first heading expansion of the metadata cells in the travel actor headings and an additional list of items from the datasets corresponding to the travel actor of the selected one of the travel actor headings.

17. The method of claim 10 wherein the data entry signal further includes a return date.

18. The method of claim 10 wherein the data entry signal further includes one or more of a fare class and a range of departure dates and a range of return dates.

19. A method for controlling a graphical interface of a computing device to generate a plurality of data cohorts representing commercial options comprising:
generating, on a display device, a grid; the grid having a first axis including attribute headings; the grid having a second axis including vendor headings;
generating cells within the grid; each cell including metadata from datasets matching their respective attribute headings and vendor headings;
upon receiving a selection of a vendor heading and an attribute heading, generating on the display device a first heading expansion of the metadata of the cell intersecting the vendor heading and the attribute heading;
upon receiving a selection of just a vendor heading, generating on the display device an expansion of the metadata from the datasets corresponding to each cell of the vendor heading; and,
upon receiving a selection of just an attribute heading, generating on the display device an expansion of the metadata from the datasets corresponding to each cell of the attribute heading.

20. The method of claim 19 wherein a first one of the attribute headings is based on a lowest price and a second one of the attribute headings is based on a duration of time to fulfill the commercial option.
